(19) United States
(12) Patent Application Publication
(10) Pub. No.: US 2012/0148770 A1
(43) Pub. Date: Jun. 14, 2012

(54) FUSED QUARTZ TUBING FOR PHARMACEUTICAL PACKAGING

(75) Inventors: Tianjun Rong, Shanghai (CN); Samuel Conzone, Castleton, NY (US); Martin Lawrence Panchula, Eastlake, OH (US)

(73) Assignee: MOMENTIVE PERFORMANCE MATERIALS, INC., Albany, NY (US)

(21) Appl. No.: 13/391,527

(22) PCT Filed: Aug. 20, 2010
(86) PCT No.: PCT/US2010/046189

§ 371 Date: Feb. 24, 2012

Related U.S. Application Data
(60) Provisional application No. 61/235,823, filed on Aug. 21, 2009.

(51) Int. Cl. B32B 1/02; C03C 3/076; C03C 3/083; C03C 3/06; C03C 3/095

(52) U.S. Cl. 428/34.4; 501/54; 501/64; 501/68; 501/55

(57) ABSTRACT

A high silica glass composition comprising about 82 to about 99.9999 wt. % SiO₂ and from about 0.0001 to about 18 wt. % of at least one dopant selected from Al₂O₃, CeO₂, TiO₂, La₂O₃, Y₂O₃, Nd₂O₃, other rare earth oxides, and mixtures of two or more thereof. The glass composition has a working point temperature ranging from 600 to 2,000° C. These compositions exhibit stability similar to pure fused quartz, but have a moderate working temperature to enable cost effective fabrication of pharmaceutical packages. The glass is particularly useful as a packaging material for pharmaceutical applications, such as, for example pre-filled syringes, ampoules and vials.

### CROSS-REFERENCE TO RELATED APPLICATION

This application claims priority to and the benefit of U.S. Provisional Patent Application No. 61/235,823, entitled “Fused Quartz Tubing for Pharmaceutical Packaging,” filed on Aug. 21, 2009, and PCT Application No.: PCT/US2010/046189 entitled “Fused Quartz Tubing for Pharmaceutical Packaging”, filed on Aug. 20, 2010, both of which are incorporated herein in its entirety by reference.

### BACKGROUND OF THE INVENTION

There has been a recent trend in the pharmaceutical market toward the increased use of biological (protein-based) drugs that are more “sensitive” than traditional drugs. With these types of drugs, the topic of drug/container interaction becomes increasingly important due to the lower stability of these drugs and their propensity to degrade during storage, especially when formulated as a liquid. Because of this, extractable substances (e.g. dissolved cations) coming from the pharmaceutical packaging container can cause issues with regard to efficacy and purity with these drugs (including drug instability, toxicity, etc). A Review of Glass Types Available for Packaging, S. V. Sangra, Journal of the Parenteral Drug Association, March-pr., 1979, Vol. 33, No. 2, pp. 61-67.

Cationic extraction from traditional glasses used in pharmaceutical packaging can create issues with the purity and/or effectiveness of such protein-based drugs. The mechanism of cationic extraction is typically hydronium/alkali ion exchange that causes a pH increase, which is then followed by bulk dissolution, especially in Type I (e.g., borosilicate, such as Schott Fiolax®) and Type II (soda lime silicate) glasses. The poor chemical durability of these glasses arises from the fact that soluble cations, such as Na⁺, Li⁺, K⁺, Mg²⁺, Ca²⁻ and/or Ba²⁺ are used to flux these glasses to achieve a suitably low working point temperature that makes them highly processable with standard glass melting equipment (see, e.g., U.S. Pat. Nos. 5,782,815 and 6,027,481).

Glasses without chemical modifiers (e.g., alkali metals, borates, alkaline earth metals) such as fused quartz glass are preferable from a chemical purity (low extractables) and chemical durability perspective, but such glasses may be difficult to manufacture due to the high processing temperatures required (typically >2,000° C.). Even when fused quartz glasses can be melted and formed into tubing, it is then often difficult to flame convert them into pharmaceutical packages (vials, syringe barrels, ampoules, etc), due to a high working point temperature (>1,700° C.). Thus, such glasses have generally not been used to manufacture pharmaceutical packaging. U.S. Pat. Nos. 6,200,658 and 6,537,626 show that efforts have been made to coat the interior surfaces of traditional glass containers with a layer of silica to reduce extractables (e.g. Schott Type I plus®). Providing coated articles, however, are cumbersome and expensive and, therefore, not widely accepted in the pharmaceutical packaging market. Thus, there is a need for a cost-effective pharmaceutical packaging glass that exhibits low extractables and leaching with a moderate working point temperature that can be used in pharmaceutical packaging applications.

### BRIEF DESCRIPTION

Drugs are packaged in various glass pharmaceutical containers, including single-use pre-filled syringes, cartridges, ampoules, vials and the like. In one aspect, the present invention provides a pharmaceutical packaging comprising a low softening point high silicate (substantially modifier free) glass tubing that can be flame converted to form traditional pharmaceutical packages (e.g., syringe barrels, cartridges, ampoules, vials, etc). The tubing does not contain appreciable amounts of traditional glass modifiers (e.g., alkali metals, alkaline earth metals, and borate ions), and the resulting packaging is thus highly resistive to cationic extraction when placed in contact with an aqueous-based solution intended for drug formulation. Applicants have found that the working point temperature and the viscosity of the glass (at a particular temperature) can be reduced through additions of non-traditional-modifiers to achieve a working point temperature that is acceptable for use in the fabrication of pharmaceutical packaging (e.g., flame conversion).

In one aspect, a glass composition in accordance with the present invention utilizes non-traditional modifier dopants (oftentimes referred to as intermediates within the glass science community), such as Al₂O₃, GₑO₂, Ga₂O₃, CeO₂, ZrO₂, TiO₂, Y₂O₃, La₂O₃. Nd₂O₃, other rare earth oxides, and mixtures of two or more thereof, to achieve a high wt % content silica glass with lower working point temperature, and lower viscosity (at a particular temperature) as compared to pure fused quartz while retaining the chemical inertness with respect to drugs similar to pure fused quartz glass. It has been found that incorporating non-traditional modifiers into the fused quartz glass effectively reduces the working point temperature by up to several hundred Kelvin and, therefore, enables rapid flame conversion/processing of tubing into pharmaceutical containers, while also enabling the glass to retain the excellent chemical durability and a resistance to cation extraction/leaching characteristic of quartz glass.

The dopants listed above are selected based on the ability of these cations to reduce the working temperature of fused silica, while retaining a chemical durability that will be extremely resistant to cationic extraction when the resulting glass is placed into contact with an aqueous solution intended for drug formulation. This resulting, modified glass tubing can be fabricated into various pharmaceutical packages, including syringe barrels, cartridges, ampoules, and vials. At the same time, the chemical inertness of this glass renders it superior to borosilicate and soda lime silicate glasses that are traditionally used for pharmaceutical packaging.

### DESCRIPTION OF THE DRAWINGS

FIG. 1 illustrates the viscosity as a function of temperature of glass compositions in accordance with aspects of the present invention.

### DETAILED DESCRIPTION

Although the terms may be used to denote compositions or articles of different materials (different silica concentrations), as used herein, the term “glass” may be used interchangeably with “quartz glass” or “quartz” or “fused quartz,” referring to a composition, a part, a product, or an article formed by melting a mixture comprising natural or synthetic sand (silica). It is well known that the viscosity of a glass will decrease as its temperature increases. Thus, as used herein, the terms “working point temperature” and “working temperature” are both used to mean the temperature at which the glass reaches a viscosity of 10⁴ poise or below, and the softening point describes the temperature where the viscosity reaches 10^{7.6} poise. Either or both natural or synthetic sand (silica) can be used in the composition of the invention, and the term silica is used to denote compositions comprising either naturally occurring crystalline silica such as sand/rock, synthetically derived silicon dioxide (silica), or a mixture of both. The term “sand” may be used interchangeably with silica, denoting either natural sand or synthetic sand, or a mixture of both.

Sand Component: The silica (SiO₂) used in the glass compositions of the present embodiments can be synthetic sand, natural sand, or a mixture thereof. In one embodiment, the amount of SiO₂ in the glass composition ranges from about 82 to about 99.9999%. In a second embodiment, the glass comprises a light-transmissive, vitreous composition with an SiO₂ content of at least about 90 wt. %.

Dopant Component(s): Depending on the desired properties in the final product, a number of different dopants and mixtures thereof may be added to the silica. Dopants are selected such that they reduce the working point temperature of the glass and its viscosity at a particular temperature and also such that the final glass product will exhibit low extractables and/or leaching of ions into drugs, aqueous drug formulations, or other compositions that come into contact therewith. Particularly suitable dopants are those that exhibit low solubility in the various (aqueous-based) contemplated drug compositions. Examples of suitable dopants include Al₂O₃, GₑO₂, Ga₂O₃, CeO₂, ZrO₂, TiO₂, Y₂O₃, La₂O₃O, Nd₂O₃, other rare earth oxides, and mixtures of two or more thereof. In one embodiment, the dopant is present in an amount of from about in an amount of 0.0001 to about 18% by weight of the total composition. In another embodiment, the dopant(s) may be present in an amount of from about 0.01 to about 18 wt. %, and in still another embodiment from about 0.1 to about 18 wt. %. In another embodiment, the dopant is present in an amount of from about 0.5 to about 5% by weight of the glass composition. It will be appreciated that some dopants may be added in an amount as low as about 0.01 wt. %, and may be, for example, in a range of from about 0.01 to about 0.1 wt. % including, for example, from about 0.01 to about 0.05 wt. %.

In one embodiment, the dopants are to be added in an amount to reduce the working point temperature of the resultant quartz composition to less than 1,650° C. In a another embodiment, the total amount of dopants is in the range of about 0.1 to about 18 wt. %. In still another embodiment, the total amount of dopant ranges from about 0.1 to about 8 wt. %.

In one embodiment, the dopant is neodymium oxide Nd₂O₃. In another embodiment, the dopant is aluminum oxide by itself, e.g., Al₂O₃, or a mixture of aluminum oxide and other dopants. In a fourth embodiment, the dopant is CeO₂. In yet another embodiment, titanium oxide (TiO₂) may be added. In another embodiment, the dopant comprises europium oxide, Eu₂O₃, by itself, or in combination with other dopants such as TiO₂ and CeO₂. In still another embodiment, the dopant is yttrium oxide. Of course, as previously described, the glass composition may comprise a single dopant or any suitable combination of two or more different dopants.

The high purity silicon dioxide (natural or synthetic sand) is mixed with at least one dopant selected from Al₂O₃, GₑO₂, Ga₂O₃, CeO₂, ZrO₂, TiO₂, Y₂O₃, La₂O₃, Nd₂O₃, other appropriate rare earth oxides, and mixtures of two or more thereof. The dopant(s) may be first mixed with up to 5 wt. % SiO₂ fumed silica before they are mixed into the final SiO₂ batch prior to glass melting. The mixing/blending may be conducted in processing equipment known in the art, e.g., blenders, high intensity mixers, etc, for a sufficient amount of time for the dopants to be thoroughly mixed with the silica-rich batch. This batched composition may be dried and then fused at 1,800° C. to 2,500° C. in a high induction furnace or flame fused into a homogeneous glass. In one embodiment, the mixture is continuously fed into a high temperature induction (electrical) furnace operating at temperatures in the range of up to about 2,500° C., forming tubes and rods of various sizes. In another embodiment, the mixture is fed into a mold wherein flame fusion is used to melt the composition, and wherein the molten mixture is directed to a mold forming the glass article.

Depending on the identity of the dopant and the amount of dopant present in the glass composition, the subsequent doped fused quartz glass composition exhibits a working point in the range of from about 600 to 2,000° C. In one embodiment, the glass composition exhibits a working point of from about 800 to about 1,700° C. In still another embodiment, the glass composition of from about 1,000 to about 1,550° C. In one embodiment, the doped fused quartz composition has a working point of about 1,550° C. or less. In another embodiment, the doped fused quartz glass has a working point of about 1,460° C. or less, which may be much lower than the working point of undoped quartz glass. The glass compositions may have a softening point of from about 500 to about 1,700° C. In one embodiment, the glass composition has a softening point of from about 1,000 to about 1,600° C. Due to these lower working points exhibited by these doped glasses, the rods or tubes may be subsequently shaped into various pharmaceutical packaging articles more easily (by means of for instance flame conversion) than would an undoped quartz glass.

In another embodiment, UV absorbers or blockers may be added to the glass composition to minimize the transmission of UV radiation to the contents of the pharmaceutical package, thus protecting the drug contents held within from degradation. Suitable UV absorbers include Ti, Ce, and Fe. Concentrations of 2,000 ppm and less are preferably used with concentrations of Fe down to <100 ppm to reduce coloration but still effectively block UV. Other transition metals that have similar impact and may be used at low levels without impacting color too much for thin wall vessels are Cr, Mn, Mo, V, and Zn. Oxidation state should be controlled (usually to the highest oxidation state) to minimize coloration.

In an alternate embodiment, undoped silica is used to make the glass and subsequent pharmaceutical packaging articles. Although having a higher working point temperature, these articles will also have the desired low amount of extractables as the doped glass composition above.

A glass composition in accordance with the present to form a homogenous, fused glass article. A glass article formed from a glass composition in accordance with the present invention may exhibit leaching characteristics superior to borosilicate (BiS) glasses and/or soda lime (Na—Ca) glasses. In one embodiment, a glass article in accordance with the present invention exhibits superior leaching characteristics with respect to cations or metals when the glass is subjected to HCl digestion. As used herein, “HCl digestion” means hydrothermally treating a 10.0 g sample of a glass article (that has been crushed) with 50 ml of 0.4 M HCl solution in a Parr teflon digestion bomb at 121° C. for 2 hours. In one embodiment, a glass article has the following leaching characteristics when subjected to HCI digestion: Na (<7.0 mg/L), Ca (<1.0 mg/L), B (<2.5 mg/L), Al (<1.25 mg/L) Ba (<0.003 mg/L), Fe (<0.01 mg/L), K (<0.03 mg/L), Mg (<0.01 mg/L), As (<0.02 mg/L), Cd (<0.001 mg/L), Cr (<0.008 mg/L), Pb (<0.009 mg/L), and Sb (<0.01 mg/L). In another embodiment, a glass article has the following leaching characteristics: Na (<0.1 mg/L), Ca (<0.05 mg/L), B (<0.01 mg/L), Al (<0.05 mg/L), Fe (<0.05 mg/L) Mg (<0.01 mg/L), K(<0.01 mg/L), As (<0.02 mg/L), Cd (<0.001 mg/L), Cr (<0.008 mg/L), Pb (<0.009 mg/L), and Sb (<0.01 mg/L).

In one aspect, glass compositions in accordance with the present invention are particularly suitable for forming a pharmaceutical packaging article such as, for example, pre-filled syringes, syringe barrels, ampoules, vials, and the like. A pharmaceutical package or article formed from the glass compositions should exhibit better leaching characteristics when an inner surface of the package or article is in contact with an aqueous pharmaceutical composition including, but not limited to, drug and medicinal formulations. In one embodiment, a pharmaceutical packaging article comprising the doped glass may be provided such that the article is substantially free of a coating layer disposed on the surface of the article in contact with a pharmaceutical composition. Articles employing a doped glass in accordance with the present invention, may be free of a coating and exhibit leaching characteristics when in contact with a pharmaceutical composition that is at least comparable to coated BiS or soda lime glasses and superior to uncoated BiS or soda lime glasses to prevent leaking are not required.

Aspects of the present invention may be further understood with respect to the following examples.

### EXAMPLES

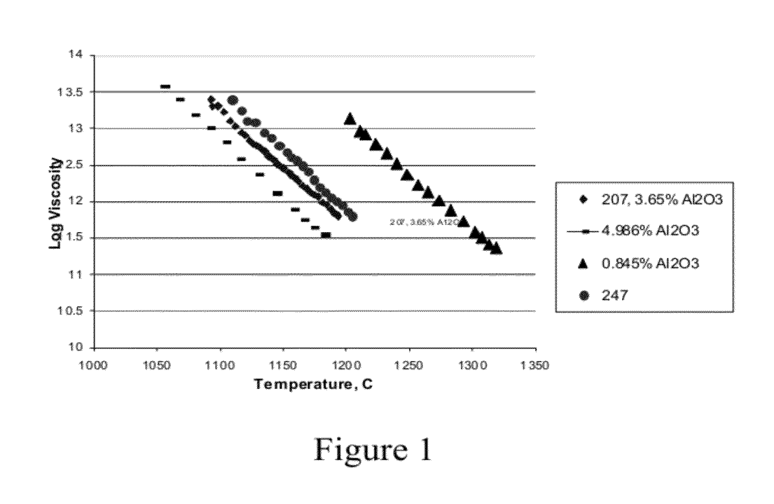

Various samples of doped fused quartz glass were produced and their respective viscosity versus temperature performance was recorded. The examples were fused according to the previously described procedure, and the viscosity (in poise) was measured as a function of temperature. The results are set forth in FIG. 1, which shows the log viscosity versus temperature. From this data, the softening temperature (temperature at which the glass has a viscosity of 10^{7.6} poise) of each sample was calculated. The results are set forth below in Table 1.

TABLE 1

| | | Softening |
|---|---|---|
| Sample ID | Compositions | Temperature |
| LSPG 1 | SiO₂ doped with 0.845 wt. % Al₂O₃ | 1558° C. |
| LSPG 2 | SiO₂ doped with 1.685 wt. % Al₂O₃ | 1535° C. |
| LSPG 3 (ID 207) | SiO₂ doped with 3.65 wt. % Al₂O₃ | 1470° C. |
| LSPG 4 | SiO₂ doped with 4.986 wt. % Al₂O₃ | 1419° C. |
| LSPG 5 (ID 247 | SiO₂ doped with 3.2 wt. % Al₂O₃, | 1454° C. |
| on chart) | 0.18 wt. % CeO₂, 0.03 wt. % TiO₂ | |

As can be seen, all of these samples exhibited a softening temperature that was dependent upon the dopant content, and many are lower than that of pure fused quartz glass which can range from 1500-1680 C. Therefore, it can be seen that increasing the dopant content in the glass (in these examples aluminum oxide) resulted in a reduction in the temperature required to achieve a particular viscosity. Furthermore, increasing the aluminum oxide content in the glass results in reduced viscosity at a particular temperature.

### Surface Extraction Testing:

The composition of Sample 5 (LSPG5) was then selected for surface extraction testing to compare the amount of extractables leached from the glass compared to the amount extracted from pure quartz glass as well as traditional pharmaceutical grade borosilicate glass and soda-lime glass containers. The containers had the following compositions and dimensions:

214A: Momentive 214 A tube ID 10× OD13-80 mm, pure fused quartz glass (available from Momentive Performance Materials Quartz Inc.)

LSPG5 LAHF D70000496 IV, 11.7×14.1×200 mm, BULKAG03 (SiO₂ glass doped with 3.2 wt. % Al2O₃, 0.18 wt. % CeO₂, 0.03 wt. % TiO₂)

BSi Schott: Type 1 glass, pharmaceutical grade borosilicate glass vial: (Outer Diameter 24 mm and height:45 mm). Typical chemical composition by wt %: SiO₂ (75%), B₂O₃ (10.5%). Al₂O₃ (5%), CaO (1.5%), BaO (<1%), Na₂O (7%) (from Schott).

BSi SD: Neutral Borosilicate Glass: Vials (Inner Diameter 22 mm and Outer Diameter 24 mm). Typical chemical composition by wt %: SiO₂ (76%), Al₂O₃ (2.5%), RO (0.5%), R₂O (8%) and B₂O₃ (12%). (From Shangdong Pharmaceutical Glass Co. Ltd.)

Na—Ca SD: Soda lime silicate glass: Vials (10 ml and 20 ml). Typical chemical composition by wt %: SiO₂ (71%), Al₂O₃ (3%), RO (12%) and R₂O (15%) (From Shangdong Pharmaceutical Glass Co. Ltd.)

### Sample Preparing and Testing:

First, the tubes or vials were crushed into 5-10 mm size pieces using a zirconia hammer. Approximately 100 g of each sample was then washed in DI water three times. After that, the crushed samples were washed with 5% HF followed by a DI water rinse. After the washed crushed samples were dried, a nylon screen mesh and zirconia mortar and pestle was used to further crush the samples into cullet with particles approximately 300 to 420 micrometers in size. Then AR grade alcohol was used to wash the cullet samples and the samples were then dried in quartz glass beaker. Then, 10.0 g of each sample was subjected to HCI digestion by hydrothermally treating a 10.0 g of a sample with 50 ml 0.4M HCl solution in a Parr teflon digestion bomb at 121° C. for 2 hours. After cooling, 40 ml of the resultant residual solution from each sample was tested for various leachants by ICP-AES testing. The results are shown in table 2.

TABLE 2
Element Leached Content In Residual Leaching Solution

| Element | 214 A | | LSPG5 | | BSi Schott | | BSi SD | | Na—Ca SD | |
|---|---|---|---|---|---|---|---|---|---|---|
| mg/L(ppm) | Mean | STDEV | Mean | STDEV | Mean | STDEV | Mean | STDEV | Mean | STDEV |
| Na | 0.018 | 0.001 | 0.057 | 0.002 | 7.883 | 0.001 | 8.740 | 0.473 | 42.341 | 7.948 |
| Ca | 0.029 | 0.009 | 0.032 | 0.005 | 1.002 | 0.104 | 0.956 | 0.067 | 2.647 | 0.030 |
| B | <0.01 | | <0.01 | | 2.710 | 0.319 | 3.322 | 0.167 | 0.102 | 0.011 |
| Al | 0.022 | 0.007 | 0.021 | 0.029 | 1.419 | 0.023 | 1.596 | 0.124 | 0.452 | 0.102 |
| Ba | <0.001 | | <0.001 | | 0.003 | 0.000 | 0.028 | 0.002 | 0.003 | 0.002 |
| Fe | 0.022 | 0.001 | 0.027 | 0.001 | 0.016 | 0.001 | 0.013 | 0.002 | 0.018 | 0.004 |
| K | 0.007 | 0.001 | 0.008 | 0.001 | 0.036 | 0.003 | 0.036 | 0.002 | 0.128 | 0.019 |
| Mg | 0.004 | 0.001 | 0.005 | 0.001 | 0.013 | 0.001 | 0.006 | 0.001 | 0.777 | 0.166 |
| As | <0.02 | | <0.02 | | 0.021 | 0.002 | 0.029 | 0.000 | 0.122 | 0.022 |
| Cd | <0.001 | | <0.001 | | <0.001 | | <0.001 | | <0.001 | |
| Cr | <0.008 | | <0.008 | | <0.008 | | <0.008 | | <0.008 | |
| Pb | <0.009 | | <0.009 | | <0.009 | | <0.009 | | <0.009 | |
| Sb | <0.01 | | <0.01 | | <0.01 | | <0.01 | | <0.01 | |

U.S. Pat. No. 6,537,626 indicated cationic extraction data for Type 1 is Schott borosilicate glass vials and Type 1 plus is comprised of vials where the interior surface had been coated with silica to minimize the cationic extraction. Type 1 Shott borosilicate glass vials exhibit relative high cationic extraction (Na(3.5 ppm), Ca(1.1 ppm), B(3.5 ppm) and Al(2.3 ppm)). Due to the pure silica coating, Type 1 plus pharmaceutical containers exhibit extremely low cationic extraction (below the detection limit of the equipment used: Na(<0.01 ppm), Ca(<0.05 ppm), B(<0.1 ppm) and Al(<0.05 ppm)). The current invention, however, provides an alternative to coated borosilicate glasses (Type 1 plus) glasses, in that it provides monolithic, homogeneous, high purity fused quartz glass and lower softening point, high silica glasses based upon doping with non-traditional modifiers that minimize cationic extraction when said containers come into contact with an aqueous drug formulation. This reduces the manufacturing complexity and high cost of the CVD-based silica coating used to manufacture Type 1 plus containers.

### Results:

The fused quartz glass sample (214A in above table) exhibited As, Cd, Cr, Pb and Sb leaching that was below detectable limits. Likewise, the As, Cd, Cr, Pb and Sb leached by the LSPG5 sample (SiO₂ glass doped with 3.2 wt. % Al₂O₃, 0.18 wt. % CeO₂, 0.03 wt. % TiO₂ as prepared above) were all below detectable limits. In contrast, the BSi SD and BSi Schott glasses, which are commonly used within the pharmaceutical packaging industry, exhibited approximately 0.2 mg/L of As (a toxic element that could potentially poison a pharmaceutical formulation).

The 214A and LSPG5 samples both exhibited B leaching that was below the detection limit, and at least 270 times less than that leached from the BSi Schott or the BSi SD borosilicate glasses. Finally, the LSPG5 and 214A samples were very resistant to Na, Ca, Al, K, and Mg leaching, while the BSi Schott, BSi SD and Na—Ca SD glasses exhibited much higher leaching of these elements as shown in the Table 2.

According to standard testing methods, LSPG5 also exhibits excellent properties with respect to Hydrolytic resistance (ISO 719)/YBB00362004 at 98° C. and YBB00252003 at 121° C. (Results: 0.00 mL hydrochloric solution/g cullet); Acid resistance (DIN 12116)/YBB00342004 (Results: 0.2 mg/dm²); Alkali resistance (ISO 695)/YBB00352004(Results: 49 mg/dm²).

(The 214A and LSPG glasses exhibit exceptionally low cationic leaching, which is expected to be similar to that from a SiO₂ coated glass container (e.g., a Type 1 plus Schott container). However, from production cost and quality control perspectives, containers produced from the glass described herein (a modified silica glass tubing with low working point temperature) would have an advantage compared with Type 1 plus technology in that the containers would be made from homogeneous low extractable glass having an appropriate working point temperature to enable direct flame conversion processing of tubing into pharmaceutical packages without the need for coating. In contrast, Type I plus containers have a silica coating that is used to “mask” the cation leaching from the homogeneous, base borosilicate glass that was used to fabricate the pharmaceutical package. The coating process is expensive and cumbersome (requiring a separate manufacturing line/process that is used to apply the silica coating to the interior of the container after flame conversion), and may not be applicable to all complex shapes/formats, especially some of the complex formats required for prefilled injectables, pens and/or other complex drug delivery packages.

The foregoing description identifies various, non-limiting embodiments of glass compositions and articles made therefrom in accordance with aspects of the present invention. Modifications may occur to those skilled in the art and to those who may make and use the invention. The disclosed embodiments are merely for illustrative purposes and not intended to limit the scope of the invention or the subject matter set forth in the following claims.

1. A silica glass composition comprising about 82 to about 99.9999 wt. % SiO₂ and about 0.0001 to about 18 wt. % of a dopant selected from f Al₂O₃, GeO₂, Ga₂O₃, CeO₂, ZrO₂, TiO₂, La₂O₃. Y₂O₃, Nd₂O₃, a rare earth oxides, and mixtures of two or more thereof.

2. The glass composition of claim 1, wherein the glass composition exhibits a working point temperature in the range of from about 600 to about 2,000.

3. The glass composition of claim 1, wherein the glass composition exhibits a softening point temperature in the range of about 500 to about 1,700 C.

4. The glass composition of claim 1, wherein the concentration of cations or metal ions leached from a glass article formed from the glass composition is lower than the concentration of cations or metals leached from a borosilicate glass and/or soda lime glass when the respective glasses are in contact with an aqueous solution.

5. The glass composition of claim 1, wherein a fused glass article formed from the glass composition exhibits the following leaching characteristics, the following species in after the glass is subjected to HCl digestion: Na (<0.1 mg/L), Ca (<0.05 mg/L), B (<0.01 mg/L), Al (<0.05 mg/L), Fe (<0.05 mg/L) Mg (<0.01 mg/L), K(<0.01 mg/L), As (<0.02 mg/L), Cd (<0.001 mg/L), Cr (<0.008 mg/L), Pb (<0.009 mg/L), and Sb (<0.01 mg/L).

6. The glass composition of claim 1, wherein a fused glass article formed from the glass composition exhibits the following leaching characteristics, the following species in after the glass is subjected to HCl digestion: Na (<7.0 mg/L), Ca (<1.0 mg/L), B (<2.5 mg/L), Al (<1.25 mg/L), Ba (<0.003 mg/L), Fe (<0.01 mg/L), K (<0.03 mg/L), Mg (<0.01 mg/L) As (<0.02 mg/L), Cd (<0.001 mg/L), Cr (<0.008 mg/L), Pb (<0.009 mg/L), and Sb (<0.01 mg./L).

7. The glass composition of claim 1, further comprising a UV blocker comprising Ti, Ce, Fe, or combinations of two or more thereof, the UV blocker being present in amount of from about 0.001 to about 0.5 wt %

8. The glass composition of claim 1, wherein the glass composition exhibits a coefficient of thermal expansion of less than 3 ppm/K.

9. The glass composition of claim 1, wherein the glass composition exhibits a coefficient of thermal expansion less than 2 ppm/K.

10. The glass composition of claim 1, wherein the glass composition exhibits a coefficient of thermal expansion of less than 1 ppm/K.

11. The glass composition of claim 1, wherein the glass exhibits no volatile borate formation on the surface of a pharmaceutical packaging container during or immediately after flame conversion.

12. The glass composition of claim 1, wherein the total dopant concentration is from about 0.0001 to about 18 wt. %.

13. The glass composition of claim 1, wherein the total dopant concentration is from about 0.01 to about 8 wt. %.

14. The glass composition of claim 1, comprising from about 0.1 to about 18 wt. % Al₂O₃.

15. The glass composition of claim 1, comprising from about 0.5 to about 5 wt. % Al₂O₃.

16. The glass composition of claim 1, comprising from about 0.1 to about 5 wt. % Al₂O₃, from about 0.1 to about 0.5 wt. % CₑO₂, and from about 0.01 to about 0.05 wt. % TiO₂.

17. The glass composition of claim 1, having a working point temperature of about 1,550° C. or less.

18. A pharmaceutical packaging container comprising a silica glass composition comprising about 82 to about 99.9999 wt. % SiO₂ and about 0.0001 to about 18 wt. % of a dopant selected from Al₂O₃, GeO₂, Ga₂O₃, CeO₂, ZrO₂, TiO₂, La₂O₃, Y₂O₃, Nd₂O₃, a rare earth oxides, and mixtures of two or more thereof

19. The pharmaceutical packaging container of claim 18 comprising from about 0.01 to about 18 wt. % of a dopant.

20. The pharmaceutical composition of claim 18 comprising from about 0.01 to about 8 wt. % of a dopant.

21. The pharmaceutical packaging container of claim 18 in the form of one of a vial, cartridge, syringe barrel, or ampoule.

22. The pharmaceutical packaging container of claim18, wherein said container is designed for the liquid or dry (lyophilized) storage of drugs.

23. The pharmaceutical packaging container of claim 18, wherein the inner surface of the packaging container is substantially free of a coating.

24. The pharmaceutical packaging container of claim 18, wherein the container exhibits the following leaching characteristics when subjected to HCl digestion: Na (<5.0 mg/L), Ca (<1.0 mg/L), B (<2.5 mg/L), Al (<1.25 mg/L), Ba (<0.003 mg/L), Fe (<0.01 mg/L), K (<0.03 mg/L), Mg (<0.01 mg/L) As (<0.02 mg/L), Cd (<0.001 mg/L), Cr (<0.008 mg/L), Pb (<0.009 mg/L), and Sb (<0.01 mg./L).

25. The pharmaceutical packaging container of claim 18, wherein the container exhibits the following leaching characteristics when subjected to HCl digestion: Na (<0.1 mg/L), Ca (<0.05 mg/L), B (<0.01 mg/L), Al (<0.05 mg/L), Fe (<0.05 mg/L) Mg (<0.01 mg/L), K(<0.01 mg/L), As (<0.02 mg/L), Cd (<0.001 mg/L), Cr (<0.008 mg/L), Pb (<0.009 mg/L), and Sb (<0.01 mg/L).

26. The pharmaceutical packaging container of claim 18, wherein the concentration of cations or metal ions leached from the container is lower than the concentration of cations or metals leached from a borosilicate glass and/or soda lime glass when the respective glasses are in contact with an aqueous solution.

27. The pharmaceutical packaging container of claim 26, wherein the aqueous solution is a liquid pharmaceutical drug formulation.
